(19) United States
(12) Patent Application Publication
(10) Pub. No.: US 2009/0265937 A1
(43) Pub. Date: Oct. 29, 2009

(54) Method of assembling leather cover of steering wheel

(75) Inventor: Eungjoo KIM, Suwon-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/339,547

(22) Filed: Dec. 19, 2008

(30) Foreign Application Priority Data
Apr. 23, 2008 (KR) 10-2008-0037516

(51) Int. Cl. B62D 1/11

(52) U.S. Cl. 29/894.1; 29/432; 29/458; 29/525.01

(57) ABSTRACT

A method of assembling a cover of a steering wheel, includes a) punching the cover, in which first and second series of sewing holes are formed at both lateral sides of the cover, b) sewing the first and second series of the sewing holes of the cover with a first thread and a second thread respectively to form first and second crossing holes in each series of the sawing holes, c) wrapping the cover around a rim of the steering wheel, d) inserting a third thread to pass the first and second crossing holes in common, e) fastening lower ends of the first, second and third threads, f) pulling upper ends of the first and second threads upwards sufficiently enough to remove a gap formed between both the lateral sides of the cover, and g) fastening the upper ends of the first, second and third threads.

### CROSS-REFERENCE TO RELATED APPLICATIONS

The present application claims priority to Korean Application Serial Number 10-2008-0037516, filed on Apr. 23, 2008, the entire contents of which are incorporated herein for all purposes by this reference.

### BACKGROUND OF THE INVENTION

1. Field of the Invention

The present invention relates to a method of assembling a leather cover of a steering wheel that improves productivity by reducing an assembly time and durability.

2. Description of Related Art

In general, a steering wheel is composed of a rim, which is the outer edge, a center hub equipped with a device that operating a horn and an airbag module for a driver and a plurality of spokes connecting the hub and the rim.

Describing the internal structure of the steering wheel, an armature member that functions as a frame and an intermediate structure made of polyurethane and assembled with the amateur member are provided, in which a leather cover is attached around the intermediated structure to improve the external appearance and the touch for the driver.

The leather cover is formed by connecting commonly three to four pieces of leather, depending on the types of steering wheels, and the pieces of leather are connected by a sewing machine.

However, methods of assembling the connected pieces of leather with the intermediate structure of the steering wheel in the related art had a problem in that because the entire sewing is manually performed by a worker, a large amount of working time is required and productivity is correspondingly decreased.

Further, when the sewing gaps (stitch gap) are increased to reduce the working time, the external appearance deteriorates and the leather cover opens.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a method of assembling a leather cover of a steering wheel that makes it possible to improve productivity by reducing a large amount of working time and durability while preventing the external appearance from deteriorating and the leather cover from opening when attaching the leather cover to a steering wheel.

In an aspect of the present invention, a method of assembling a cover of a steering wheel, include a) punching the cover, in which first and second series of sewing holes are formed at both lateral sides of the cover in a longitudinal direction thereof, the first and second series being spaced with a predetermined distance in a traverse direction of the cover, b) sewing the first and second series of the sewing holes of the cover with a first thread and a second thread respectively in the longitudinal direction of the cover to form first and second crossing holes in each series of the sawing holes, c) wrapping the cover around a rim of the steering wheel, d) inserting a third thread to pass the first and second crossing holes in common, e) fastening lower ends of the first, second and third threads, f) pulling upper ends of the first and second threads upwards in the longitudinal direction of the cover sufficiently enough to remove a gap formed between both the lateral sides of the cover, and g) fastening the upper ends of the first, second and third threads.

The method may further include a process of attaching a double-sided tape to inside of the cover after step a) or step b).

The method may further include a process of washing the steering wheel and a process of applying an adhesion to the rim of the steering wheel.

The method may further include a heat-blowing process to remove wrinkles generated on surface of the cover after step g).

The cover may be a leather cover wherein the cover is formed by connecting a plurality of pieces of leather in a line. The connecting and punching may be performed in one sewing machine.

The first thread and the second thread may be passed through the first and second series of the sewing holes in a coil shape.

Diameter of the sewing holes may be larger than diameters of the first and second threads, wherein the diameter of the sewing holes is approximately between one and a half and two times of the diameters of the first and second threads and wherein the diameters of the first and second threads are the same.

In step f) the third thread may be kept tight while the upper ends of the first and second threads are pulled upwards in the longitudinal direction of the cover.

In another aspect of the present invention, a method of assembling a cover of a steering wheel, may include connecting and punching the cover, in which the cover is formed by connecting a plurality of pieces of leather in a line, sewing holes are formed at both sides of the cover at predetermined distances in the length direction of the cover, and a first thread and a second thread are passed through the sewing holes formed in each side of the cover in a coil shape, and sewing the cover, in which a third thread is passed through a crossing hole formed in common between the first and second threads after the cover is wrapped around a rim of the steering wheel such that the first and second threads cross each other, ends of the first, second, and third threads are tied, the other ends of the first and second threads are pulled in the length direction of the cover to remove a gap between both sides of the cover, and attaching the cover to the rim of the steering wheel is finished by tying the other ends of the first, second, and third threads.

The sewing hole formed through the cover may have a diameter larger than the diameters of the first and second threads.

The connecting and punching may be performed in one sewing machine.

The third thread may be kept tight, when the other ends of the first and second threads are pulled in the length direction of the cover.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 a diagram sequentially illustrating an exemplary method of assembling an exemplary leather cover of a steering wheel according to the present invention.

FIGS. 2 to 4 are views illustrating connecting, punching, and sewing processes in the method of assembling an exemplary leather cover according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A steering wheel of a steering system of a vehicle includes a rim, which is the outer edge, a center hub equipped with a device that operating a horn and an airbag module for a driver and a plurality of spokes connecting the hub and the rim.

Describing the internal structure of the steering wheel, an amateur member that functions as a frame and an intermediate structure made of polyurethane and assembled with the amateur member are provided, in which a leather cover is attached around the intermediate structure to improve the external appearance and the touch for the driver.

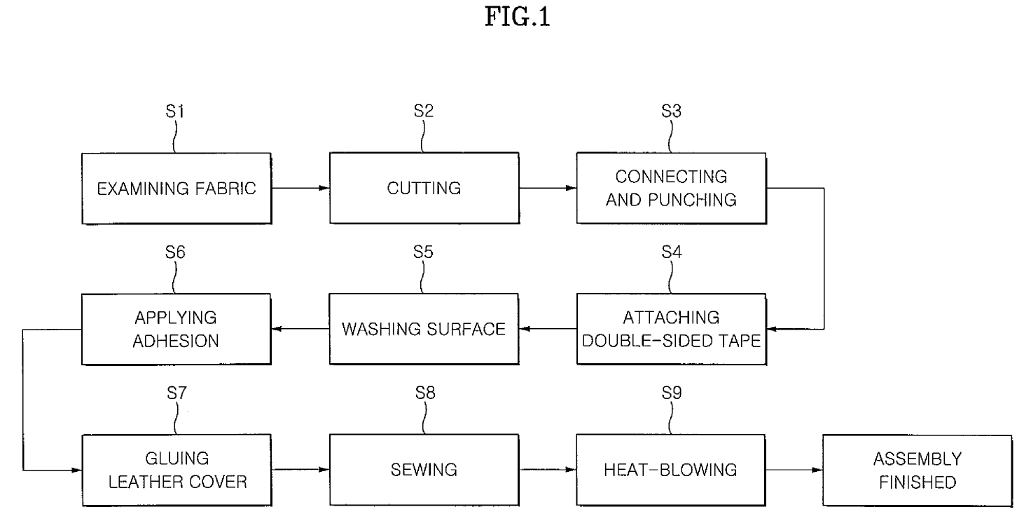

Various embodiments of the invention are characterized in that productivity is improved by reducing a large amount of working time for attaching a leather cover around a steering wheel, and a method for achieving the characteristic is described hereafter with reference to FIGS. 1 to 3.

In a first step in an assembly process, the quality of a fabric that is used as the leather cover is examined (S1).

After the quality examination is finished, a cutting process for cutting the fabric into a plurality of pieces of leather is performed by a cutting machine (S2).

The fabric is commonly cut into three to four pieces of leather for one steering wheel.

After the cutting process, connecting and punching processes are performed (S3).

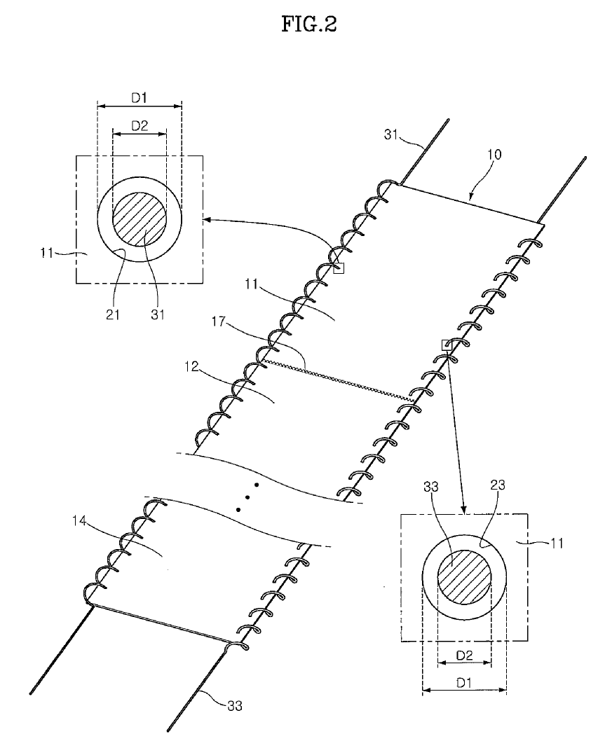

In the connecting and punching processes, as shown in FIG. 2, the pieces of leather 11, 12, . . . 14 are sewn in a line to be a leather cover 10 that fits the shape of the steering wheel.

After leather cover 10 is manufactured, sewing holes 21, 23 are formed at predetermined distances along both sides of the leather cover 10 in the length direction of leather cover 10.

After sewing holes 21, 23 are formed, a first thread 31 and a second thread 33 are passed through sewing holes 21, 23 in a coil shape.

All operations required for the connecting and punching processes are sequentially performed in one sewing machine.

The diameters D1 of sewing holes 21, 23 are larger than the diameters D2 of first and second threads 31, 33, and preferably one and a half or two times diameters D2 but is not limited thereto.

Further, it is preferable that diameters D2 of first and second threads 31, 33 are the same.

After the connecting and punching processes, a process of attaching a double-sided tape to the inside of the leather cover (the side that contacts with the steering wheel) is performed (S4), and then a process of washing the steering wheel (S5) and a process of applying an adhesion to the washed steering wheel (S6) are performed.

The adhesion is a bond that does not harm human beings, but is not limited thereto.

Subsequently, a process of gluing leather cover 10 to the rim of the steering wheel using the double-sided tape and the adhesion (S7) is performed, and then sewing process (S8) is performed to completely attach leather cover 10 to the rim of the steering wheel.

That is, the gluing process of leather cover 10 (S7) is a process of temporarily attaching leather cover 10 to the rim of the steering wheel and the sewing process (S8) is a process of completely attaching the temporarily attached leather cover 10 to the rim of the steering wheel.

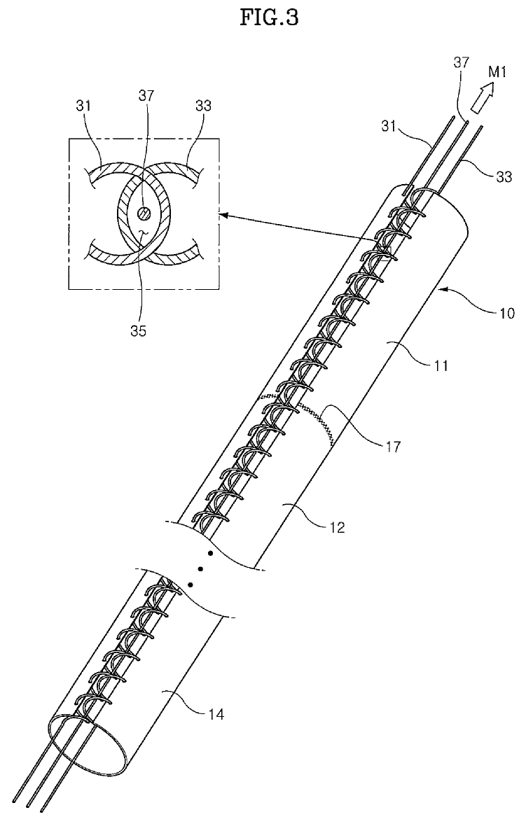

In the sewing process, as shown in FIG. 3, leather cover 10 is wrapped around the rim of the steering wheel such that first and second threads 31, 33 cross each other.

That is, both sides of leather cover 10 temporarily wrapped around the rim of the steering wheel are further wrapped such that first and second threads 31, 33 cross each other in an arc shape.

Thereafter, a third thread 37 is inserted into a crossing hole 35 formed between first and second threads 31, 33 and then ends (the lower ends in FIG. 3) of the first, second, and third threads are tied.

Further, the other ends (the upper ends in FIG. 3) of first and second threads 31, 33 that are not tied are pulled in the direction of an arrow MI shown in the figure, in the length direction of leather cover 10.

When the other ends of first and second threads 31, 33 are pulled in the direction of an arrow M1, third thread 37 is kept tight.

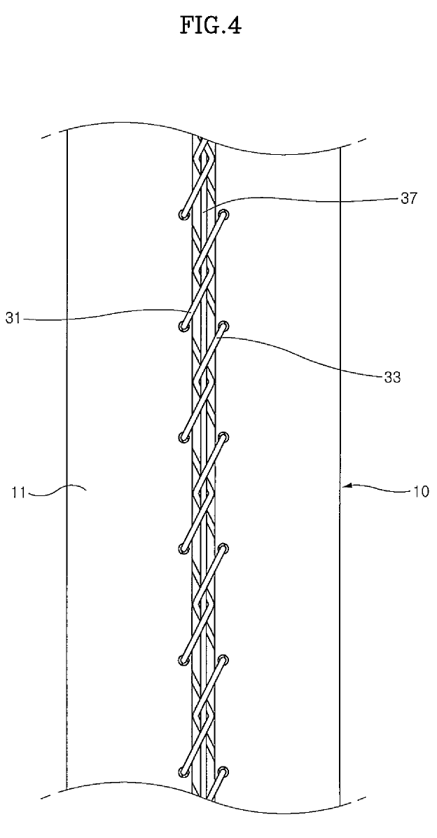

As described above, as the other ends of first and second threads 31, 33 are pulled, first and second threads 31, 33, which have been wrapped in a coil shape, are tightened in a line, and accordingly, leather cover 10, which has been open, is closed into a complete circular shape and the gap is removed, as shown in FIG. 4.

After the gap between both sides of leather cover 10 is removed by pulling the other ends of first and second threads 31, 33, the other ends (the upper ends in FIG. 3) of first, second, and third threads 31, 33, 37 are tied. Accordingly, leather cover 10 is completely wrapped around the steering wheel by tying first, second, and third threads 31, 33, 37.

After the sewing process, wrinkles are generated on the surface of leather cover 10 attached to the steering wheel. Accordingly, the assembly of leather cover 10 is finished by removing the wrinkles on leather cover 10 through a heat-blowing process (S9).

On the other hand, the reference numeral ‘17’ in FIGS. 2 and 3, which is not described, indicates the joints of the pieces of leather cover 11, 12, . . . 14 formed by sewing.

According to various embodiments of the invention described above, since leather cover 10 is attached to the steering wheel by pulling in one direction threads 31, 33 that have been passed through leather cover 10 by the sewing machine and tying them, it is possible to largely reduce the working time and improve the productivity, as compared with when a worker directly and manually attaching the leather cover by needlework.

Further, according to various embodiments of the invention, it is also possible to improve durability, that is, maintaining good external appearance after the heat-blowing process of the steering wheel, because leather cover 10 does not open.

For convenience in explanation and accurate definition in the appended claims, the term “upper” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of assembling a cover of a steering wheel, comprising:
a) punching the cover, in which first and second series of sewing holes are formed at both lateral sides of the cover in a longitudinal direction thereof, the first and second series being spaced with a predetermined distance in a traverse direction of the cover;
b) sewing the first and second series of the sewing holes of the cover with a first thread and a second thread respectively in the longitudinal direction of the cover to form first and second crossing holes in each series of the sawing holes;
c) wrapping the cover around a rim of the steering wheel;
d) inserting a third thread to pass the first and second crossing holes in common;
e) fastening lower ends of the first, second and third threads;
f) pulling upper ends of the first and second threads upwards in the longitudinal direction of the cover sufficiently enough to remove a gap formed between both the lateral sides of the cover; and
g) fastening the upper ends of the first, second and third threads.

2. The method as defined in claim 1, further comprising a process of attaching a double-sided tape to inside of the cover after step a) or step b).

3. The method as defined in claim 2, further comprising a process of washing the steering wheel.

4. The method as defined in claim 3, further comprising a process of applying an adhesion to the rim of the steering wheel.

5. The method as defined in claim 2, further comprising a process of applying an adhesion to the rim of the steering wheel and gluing the cover to the rim of the steering wheel

6. The method as defined in claim 1, further comprising a process of applying an adhesion to the rim of the steering wheel and gluing the cover to the rim of the steering wheel after step a).

7. The method as defined in claim 1, further comprising a heat-blowing process to remove wrinkles generated on surface of the cover after step g).

8. The method as defined in claim 1, wherein the cover is a leather cover.

9. The method as defined in claim 8, wherein the cover is formed by connecting a plurality of pieces of leather in a line.

10. The method as defined in claim 9, the connecting and punching are performed in one sewing machine.

11. The method as defined in claim 1, wherein the first thread and the second thread are passed through the first and second series of the sewing holes in a coil shape.

12. The method as defined in claim 1, wherein diameter of the sewing holes is larger than diameters of the first and second threads.

13. The method as defined in claim 12, wherein the diameter of the sewing holes is approximately between one and a half and two times of the diameters of the first and second threads.

14. The method as defined in claim 12, wherein the diameters of the first and second threads are the same.

15. The method as defined in claim 1, wherein in step f) the third thread is kept tight while the upper ends of the first and second threads are pulled upwards in the longitudinal direction of the cover.

16. A method of assembling a cover of a steering wheel, comprising:
connecting and punching the cover, in which the cover is formed by connecting a plurality of pieces of leather in a line, sewing holes are formed at both sides of the cover at predetermined distances in the length direction of the cover, and a first thread and a second thread are passed through the sewing holes formed in each side of the cover in a coil shape; and
sewing the cover, in which a third thread is passed through a crossing hole formed in common between the first and second threads after the cover is wrapped around a rim of the steering wheel such that the first and second threads cross each other, ends of the first, second, and third threads are tied, the other ends of the first and second threads are pulled in the length direction of the cover to remove a gap between both sides of the cover, and attaching the cover to the rim of the steering wheel is finished by tying the other ends of the first, second, and third threads.

17. The method as defined in claim 16, wherein the sewing hole formed through the cover has a diameter larger than the diameters of the first and second threads.

18. The method as defined in claim 16, the connecting and punching are performed in one sewing machine.

19. The method as defined in claim 16, wherein the third thread is kept tight, when the other ends of the first and second threads are pulled in the length direction of the cover.
